(19) United States
(12) Patent Application Publication
(10) Pub. No.: US 2009/0091071 A1
(43) Pub. Date: Apr. 9, 2009

(54) Glazing Panel Handling Tool

(76) Inventor: William Finck, Essex (GB)

Correspondence Address: GORDON & JACOBSON, P.C., 60 LONG RIDGE ROAD, SUITE 407, STAMFORD, CT, 06902, US

(21) Appl. No.: 12/089,122

(22) PCT Filed: Oct. 4, 2006
(86) PCT No.: PCT/GB2006/003693

§ 371 Date: Aug. 1, 2008

(30) Foreign Application Priority Data
Oct. 4, 2005 (GB) 0520209.8

(51) Int. Cl. B25B 11/00

(52) U.S. Cl. 269/21

(57) ABSTRACT

The glazing panel handling tool has an elongate grab handle bridge connecting spaced suction pad devices. The grab handle bridge is rotatable about a longitudinal axis in order to cause the separation distance between the suction devices to be varied. The adjustability aids in the utility of the tool in glazing panel handling situations.

### BACKGROUND OF THE INVENTION

1. Field of the Invention

The present invention relates to a glazing panel handling tool and particularly to such a tool enabling fitting of glazing panels accurately.

2. State of the Art

Glazing panel handling tools are known for use in aiding of fitting glazing panels in architectural or vehicle glazing openings or frames. An exemplary tool is disclosed in, for example, DE 20103755. In the arrangement disclosed in DE 20103755, a pair of suction devices are separated by a grab handle bridge. The suckers securely affix to a glazing panel enabling the glazing panel to be lifted by means of the grab handle bridge.

### SUMMARY OF THE INVENTION

An improved arrangement has now been devised enabling use as with prior art arrangements and also additional functionality to be realised.

According to a first aspect, the present invention provides a glazing panel handling tool comprising:
spaced first and second suction pad devices;
an elongate grab handle bridge connecting the first and second suction pad devices; the grab handle bridge being rotatable about a longitudinal axis in order to cause the separation distance between the suction devices to be varied.

Typically in addition to the grab handle bridge adjustment enabling variation of separation between the first and second suction pad devices, one or both of the suction devices may be pivotally or gimbal mounted with respect to the bridge. This enables the variation in curvature for example between different glazing panels to be accommodated. Such a pivoting connection between the suction pad devices and the bridge is shown in, for example, DE20103755.

The connection between at least one of the suction pad devices and the bridge is adjustable to vary the separation between the first and second suction pad devices. Preferably the connection between both of the suction pad devices and the bridge is adjustable to vary the separation between the first and second suction pad devices.

Desirably a screw thread connection is provided between one or both of the suction pad devices and the bridge. The screw thread connection is thereby adjustable to vary the separation between the first and second suction pad devices, in response to rotation of the grab handle bridge.

In certain embodiments the bridge may include receiving means for receiving an actuation tool to effect adjustment. A recess, slot or aperture may for example be provided, for receiving an actuation tool (such as a lever).

In a preferred embodiment, the bridge adjustment arrangement includes a detent arrangement for holding the bridge arrangement in a home orientation with respect to the suction pads. The detent arrangement beneficially includes biassing means to provide resistance against movement from the home orientation. Desirably, the detent arrangement comprises a projection arranged to locate in a recess in the home orientation. It is preferred that the projection and recess are carried by respective components of the adjustment arranged to threadingly matingly engage with one another.

It is preferred that the first and second suction pad devices include a flexible sucker membrane and an actuator arranged to act to reconfigure the sucker membrane between a suction enhanced and a suction relieved configuration. The sucker membrane advantageously is of rubber or similar elastomeric material. Beneficially, the actuator comprises a cam lever.

The flexible sucker membrane preferably includes a peripherally extending flexible sucker skirt. The skirt preferably extends peripherally outwardly beyond a supporting housing of the suction device.

According to a second aspect, the invention provides a method of adjusting the fixing position of a vehicle glazing panel with respect to an opening, using a tool according to the first aspect of the invention, wherein a first of the suction devices is attached to the glazing panel and a second of the suction devices is attached to a surface adjacent the opening, wherein the bridge adjustment arrangement is operated to vary the separation between the first and second suction pad devices, and so adjust the fixing position of the glazing panel with respect to the opening.

The invention thus provides a novel and inventive tool for glazing panel fitment and also a novel technique. The tool enables the glazing panel to be lifted and fitted in position and then fine adjustment made to position the panel accurately in the frame or opening. The panel may then be held in position whilst the bonding material (typically resin interposed between the glazing panel and the frame) cures.

The invention will now be further described in a specific embodiment, by way of example only, and with reference to the accompanying drawings.

### BRIEF DESCRIPTION OF THE DRAWINGS

FIG. 1 is a schematic perspective view of a tool according to the invention;

FIGS. 2a and 2b are views of parts of the bridge of the tool of FIG. 1;

FIGS. 3 and 4 are views of the components of the bridge assembled; and

FIG. 5 is a schematic view of the tool of the invention as used in the method of the invention.

### DETAILED DESCRIPTION OF THE PREFERRED EMBODIMENTS

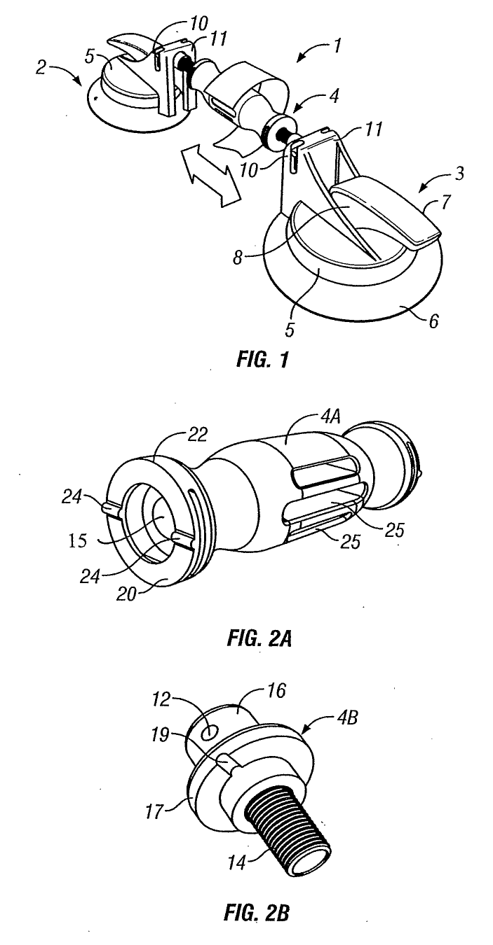

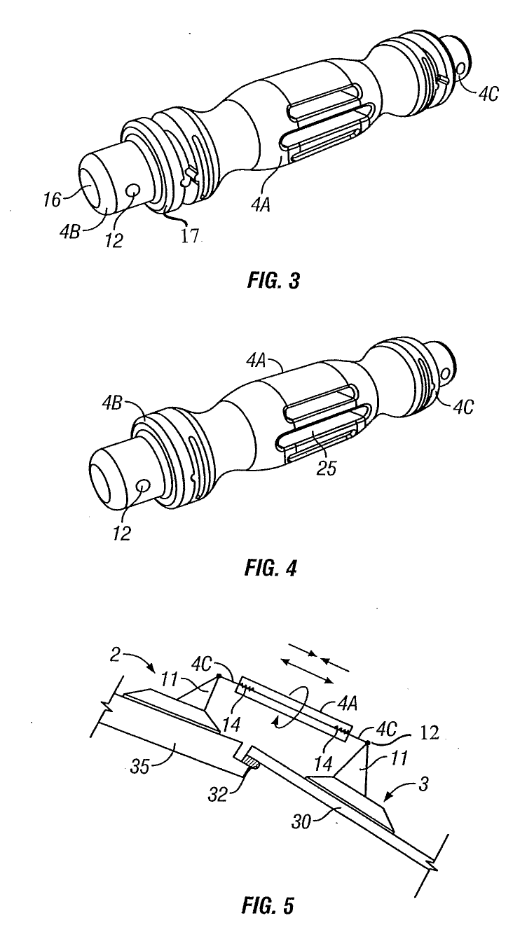

Referring to the drawings, and initially to FIG. 1, there is shown a glazing panel handling tool, comprising a pair of sucker suction devices 2,3 mounted one at either end of a grab handle bridge 4. The sucker suction devices 2,3 comprises a hard plastics mounting shell 5, to the underside of which is secured a flexible rubber membrane having a body disc (not visible in the figures) and an integral peripherally extending flexible skirt 6 extending outwardly beyond the mounting shell 5. An actuation cam lever 7 is pivotally mounted at pivot 8, to the hard plastics mounting shell 5, the primary purpose of the actuation lever being to energize or de-energize the sucker. Such arrangements are known in the art and an exemplary such lever actuator arrangement is disclosed, for example, in DE 20103755, in which a lever having a cam is movable to urge a cam follower pin to push down the concave dish of the flexible sucker body 3, so energizing or de-energizing the suction device. The present arrangement is designed to operate in this manner. The sucker suction devices 2,3 are pivotally mounted with respect to the grab handle bridge 4 at pivots 10, in which pivot formations carried by the upstands 11 of the housings 5 are received in bores 12 at opposed ends of the grab handle bridge 4. The pivotal connection of the sucker suction devices 2,3 to the grab handle bridge 4 enable the tool to adapt glazing panels of a variety of differing curvatures, as is common for windscreens for different models of vehicle. Also it enables the tool to be used in alternative ways as will be described later. Other mechanical connections may be used to achieve this functionality, for example a gimbal mount may be used as an alternative.

The grab handle bridge 4 spanning between the spaced sucker suction devices 2,3 comprises a central generally tubular portion 4a and end mounting portions 4b, 4c. The end mounting portions 4b, 4c carry screw threaded shafts 14 arranged to mate in screw threaded bores 15 provided at the opposed ends of the central tubular portion 4a. The screw threads are of the opposed thread sense at either end of the grab handle bridge 4. The end mounting portions have distal terminal bosses 16 provided with the pivot receiving bore 12, and a flange 17 intermediate the boss 16 and the screw threaded shaft 14. The face of flange 17 is provided with rounded locating recesses 19 extending diametrically. At each end of the grab handle bridge 4 is a facing flange washer 20 which is joined by a bridge 22 to the main body of the grab handle bridge 4. The bridge connection 22 provides a resilient connection for the facing flange washer 20. The facing flange washer 20 carries diametrical rounded ribs 24 arranged to mate with the recesses 19.

When assembled the end mounting portions 4b, 4c are threadably mated with the threaded bores 15 and screwed home until the ribs 24 snap into and locate with the recesses 19. In this position the sucker suction devices are mounted with respect to the grab handle bridge 4 for normal use in lifting and handling glazing panels. The resilient biassing provided by the connection of the facing flange washer 20 is sufficient to ensure that the screw threaded end mountings 4a, 4b do not unscrew accidentally from the central tubular portion 4a.

In certain situations however it has been realised that it may be desirable to conveniently and controllably enable the separation between the sucker suction devices to be changed. In the embodiment described it is possible to change the separation of the sucker suction devices 2,3 by means of rotating (by hand or using a lever inserted in to slots or apertures 25) the central portion 4a of the grab handle bridge 4 about its axis and with respect to the end mounting portions 4b,4c. This causes the ribs 24 to disengage from the home position nested in the recesses 19 and the sucker suction devices to be urged apart. Conversely, the tool may be set up in a start configuration in which the end mounting portions are not screwed fully to their home position in which the ribs 24 are engaged nested in the recesses 19. The central portion 4a of the grab handle bridge 4 may then be rotated (in the opposite sense) about its axis and with respect to the end mounting portions 4b,4c in order to draw the sucker suction devices 2,3 closer together. A practical application of this latter technique is realised as follows.

A vehicle windscreen 30 is set in position in a generally correctly aligned position in an aperture frame in a vehicle chassis, with bonding resin 32 interposed. As shown in FIG. 5, the tool is then set up having the sucker suction device 2 mounted to the vehicle roof surface 35 above the windscreen 30 and the sucker suction device 3 mounted to the surface of the windscreen. In order to accurately fine tune the position of the windscreen vertically in the opening, the central portion of the grab handle bridge 4 can be rotated either clockwise or anticlockwise to move the position of the windscreen upwardly or downwardly. Two or more devices can be utilised in this way and one or more devices arranged to similarly fine tune sideways adjustment of the windscreen position.

Accordingly, the tool of the present invention can be used both to lift the glazing panel into position and also to fine tune positionally adjust the glazing panel once initially placed.

1. A glazing panel handling tool, comprising:
spaced first and second suction pad devices; and
an elongate grab handle bridge between the first and second suction pad devices, the grab handle bridge being rotatable about a longitudinal axis in order to cause variation in a separation distance between the suction pad devices.

2. A tool according to claim 1, wherein rotation of the grab handle bridge selectively incrementally draws the suction pad devices toward one another, or incrementally drives the suction pad devices apart from one another, depending upon a direction of rotation.

3. A tool according to claim 1, wherein a connection between both of the suction pad devices and the grab handle bridge is adjustable to vary the separation distance between the first and second suction pad devices.

4. A tool according to claim 1, further including a screw thread connection between one or both of the suction pad devices and the grab handle bridge, the screw thread connection being adjustable to vary the separation distance between the first and second suction pad devices.

5. A tool according to claim 1, wherein the grab handle bridge includes a receiving means for receiving an actuation tool to effect adjustment of the separation distance.

6. A tool according to claim 5, wherein the receiving means comprises a recess, slot or aperture for receiving the actuation tool.

7. A tool according to claim 1, further including a detent arrangement for holding the grab handle bridge in a home orientation with respect to one or both of the suction pad devices.

8. A tool according to claim 7, wherein the detent arrangement includes resilient biasing means to provide some resistance against movement from the home orientation.

9. A tool according to claim 8, wherein the detent arrangement comprises a projection arranged to locate in a recess in the home orientation.

10. A tool according to claim 9, wherein the projection and recess are carried by components of the tool arranged to threadingly matingly engage with one another.

11. A tool according to claim 1 wherein the first and second suction pad devices include a flexible sucker membrane and an actuator arranged to act to reconfigure the sucker membrane between a suction enhanced and a suction relieved configuration.

12. A tool according to claim 11, wherein the actuator comprises a cam lever.

13. A tool according to claim 11, wherein the flexible sucker membrane includes a peripherally extending skirt.

14. A tool according to claim 13, wherein the peripherally extending skirt extends peripherally outwardly beyond a supporting housing of the suction pad devices.

15. A method of adjusting a fixing position of a vehicle glazing panel with respect to an opening, comprising:
using a tool according to claim 1,
wherein a first of the suction pad devices is attached to the glazing panel and a second of the suction pad devices is attached to a surface adjacent the opening, and
wherein the tool is operated to vary the separation distance between the first and second suction pad devices to adjust a fixing position of the glazing panel with respect to the opening.
